(19) United States
(12) Patent Application Publication
(10) Pub. No.: US 2014/0335321 A1
(43) Pub. Date: Nov. 13, 2014

(54) EMBOSSED POLYMER SHEET

(71) Applicant: PALZIV GROUP, Bet Shean (IL)

(72) Inventors: Benjamin Joshua Reisman, Bet Shean (IL); Baruch Zur, Bet Shean (IL); Gregory A. Brooker, Louisburg, NC (US)

(21) Appl. No.: 14/362,331

(22) PCT Filed: Nov. 29, 2012
(86) PCT No.: PCT/US12/67074

§ 371 Date: Jun. 2, 2014

Related U.S. Application Data
(60) Provisional application No. 61/566,425, filed on Dec. 2, 2011.

(51) Int. Cl. B29C 47/00; B32B 3/30

(52) U.S. Cl. CPC B29C 47/0061; B29C 47/0042; B32B 3/30; B29K 2023/04; B29L 2007/001
USPC 428/172; 264/296; 264/48; 156/244.25; 156/78; 526/352; 521/143; 428/156

(57) ABSTRACT

A polymeric sheet comprising: a first surface and a second surface; and a first embossed pattern on at least one of the first surface or the second surface and method of preparing same is provided. In one aspect, the sheet comprises at least two protrusions, the at least two protrusions direct, impede, and/or control gas movement between the at least two protrusions when arranged in contact with a surface and externally compressed. In another aspect, the sheet is at least partially cross-linked and/or foamed.

### CROSS-REFERENCE TO RELATED APPLICATIONS

This application is filed under the provisions of 35 U.S.C. §371 and claims the benefit of International Patent Application No. PCT/US2012/067074, filed on Nov. 29, 2012, which claims the benefit of U.S. Provisional patent application 61/566,425, filed in the United States Patent and Trademark Office on Dec. 2, 2011; all of which are hereby incorporated by reference in their entirety.

### TECHNICAL FIELD

This invention generally relates to a polymeric sheet having functional embossing and methods of forming same.

### BACKGROUND

The production of polyolefin foams involves foaming of the material by creating voids. In the foaming step, a blowing agent is activated or introduced to release gas which is entrapped within the cell units of the matrix, thus forming small “air bubbles”.

The polyolefin can be cross-Inked to provide cross-linked polyolefin foams. In the cross linking step covalent bonds are formed between the polymer creating a three dimensional macroscopic matrix, which provides the material both physical and chemical strength and robustness. Electron beam, silane grafting and peroxides are the main three techniques used for crosslinking of polyolefin foams. Typically, for electron beam irradiation, an extruded polymer sheet containing the chemical foaming (blowing) agent is subjected to intense electron beam energy which results in crosslinking. For chemically crosslinked polymers (e.g. polyolefins), the crosslinking agent, usually peroxide, is compounded into the polymer along with the foaming agent. In an organosilane crosslinking system, free radical generating compounds react with a polyolefin to forms a silane grafted polyolefin, that when mixed with a silanol condensation catalyst, moisture, and heat, creates a silane-crosslinked polyolefin.

### SUMMARY

In accordance with a first embodiment of the present disclosure, an embossed polymeric sheet is provided. The sheet comprising a first surface and a second surface; and a first embossed pattern on at least one of the first surface or the second surface, where the embossed pattern is at least two protrusions, the at least two protrusions direct, impede, and/or control gas movement between the at least two protrusions when arranged in contact with a surface and externally compressed.

In accordance with a second embodiment of the present disclosure, a process for producing a continuous embossed polymeric sheet is provided. The process comprising: i) continuously feeding into a mixing arrangement set at a temperature of between 60° C. and 200° C. a blend of at least one polymeric resin, optionally a blowing agent, and optionally a cross-linking agent to form therein a homogenous melt; ii) transferring said melt into an extrusion line constructed to form a continuous sheet of said melt; iii) optionally, conveying the continuous sheet into a heating module for heating said continuous sheet to a first temperature to obtain a polymeric sheet at least partially chemically cross-linked, said first temperature being lower than that required for activating said optional blowing agent; iv) optionally, heating the cross-linked polymeric sheet to a second temperature allowing activation of said blowing agent, to obtain a continuous, at least partially cross-linked foamed polymeric sheet; and v) embossing on at least one surface of said heated polymeric sheet an arrangement of at least two protrusions.

In accordance with a third embodiment of the present disclosure, a method of controlling gas flow between a surface and a polymeric sheet is provided. The method comprising: providing a polymeric sheet comprising a first surface configured for contacting the surface; and an opposing second surface; wherein the first surface comprises a first embossed pattern of at least two protrusions configured to direct, impede, and/or control gas movement between the surface and the polymeric sheet.

In accordance with a fourth embodiment of the present disclosure, a polymeric sheet is provided. The sheet comprising: at least a partially cross-linked, closed-cell, foamed polymeric material, the sheet having a first surface and a second surface; and an embossed pattern on at least one of the first surface or the second surface.

In accordance with a fifth embodiment of the present disclosure, a process for producing a continuous, at least partially cross-linked, foamed polymeric sheet is provided. The process comprising: i) providing a homogenous polymeric melt at a predetermined temperature, the melt comprising a blowing agent having an activation temperature, and cross-linking agent, the predetermined temperature of the melt being less than the blowing agent activation temperature; ii) transferring said melt into an extrusion line constructed to form a continuous sheet of said melt; iii) conveying the continuous sheet into a heating module for heating said continuous sheet to a first temperature to at least partially cross-link the polymeric sheet, said first temperature being lower than the activation temperature of said blowing agent; iv) heating the cross-linked polymeric sheet to a second temperature at or above the activation temperature of said blowing agent, to obtain a continuous, at least partially cross-linked foamed polymeric sheet; and v) embossing on at least one surface of said at least partially cross-linked foamed polymeric sheet an arrangement of protrusions.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1 is a schematic flow diagram illustrating the main steps for performing the process in accordance with the broadest aspect of the present disclosure.

FIGS. 2A-2D are schematic flow diagrams illustrating alternative, more specific steps of the process disclosed in FIG. 1.

FIG. 3 is a schematic continuous foam sheet production process in accordance with the broadest aspect of the present disclosure.

FIG. 4 is an alternative, schematic continuous foam sheet production process in accordance with the broadest aspect of the present disclosure.

FIGS. 5A-5H are representations of embossed patterns in accordance with the broadest aspect of the present disclosure.

FIG. 5G is an exemplary foamed article with bubbled surface prepared in accordance with the broadest aspect of the present disclosure.

FIG. 6 is a detailed representation of an embossed pattern in accordance with the broadest aspect of the present disclosure.

FIG. 7 is a representation of an embossed pattern in accordance with the broadest aspect of the present disclosure.

### DETAILED DESCRIPTION

The present disclosure concerns the development of polyolefin polymeric foams with embossing for providing functionality to the underlayer. As may be appreciated by those versed in the art of polymeric foams, synthetic polymeric foams having specifically designed embossed patterns on one or more surfaces provides various advantages, for example, as an underlay of carpeting used in high traffic areas, soundproofing, insulation, hard floor padding, etc. In one aspect, the floor-side (or sub-floor) of the foamed sheet comprises functional embossing that controls air flow between the sub-floor (or substrate) and the flooring itself. A predetermined arrangement of raised protrusions in the foamed sheet surface direct, impede, and/or control gas (e.g., air) movement during use of the flooring, and, when not in use, maintain passive air flow between the sub-floor and flooring. The present arrangement of protrusions prevent degradation to the flooring/subflooring (e.g., by minimizing contact area of the underlay with the floor) and the foamed underlay sheet itself (e.g., by dispersing compression stresses to a plurality of structures).

Thus, the present disclosure provides a polymeric sheet comprising a first side and a second side opposed to the first side; and (b) an embossed pattern on at least one side. The sheet can be at least partially cross-linked and/or foamed. The polymeric sheet can be of thermoplastic, a curable elastomer, or thermoplastic elastomer. The sheet can comprise a closed-cell foam structure. Manufacturing methods of preparing the embossed polymeric sheet are provided. In one aspect, the manufacturing is continuous.

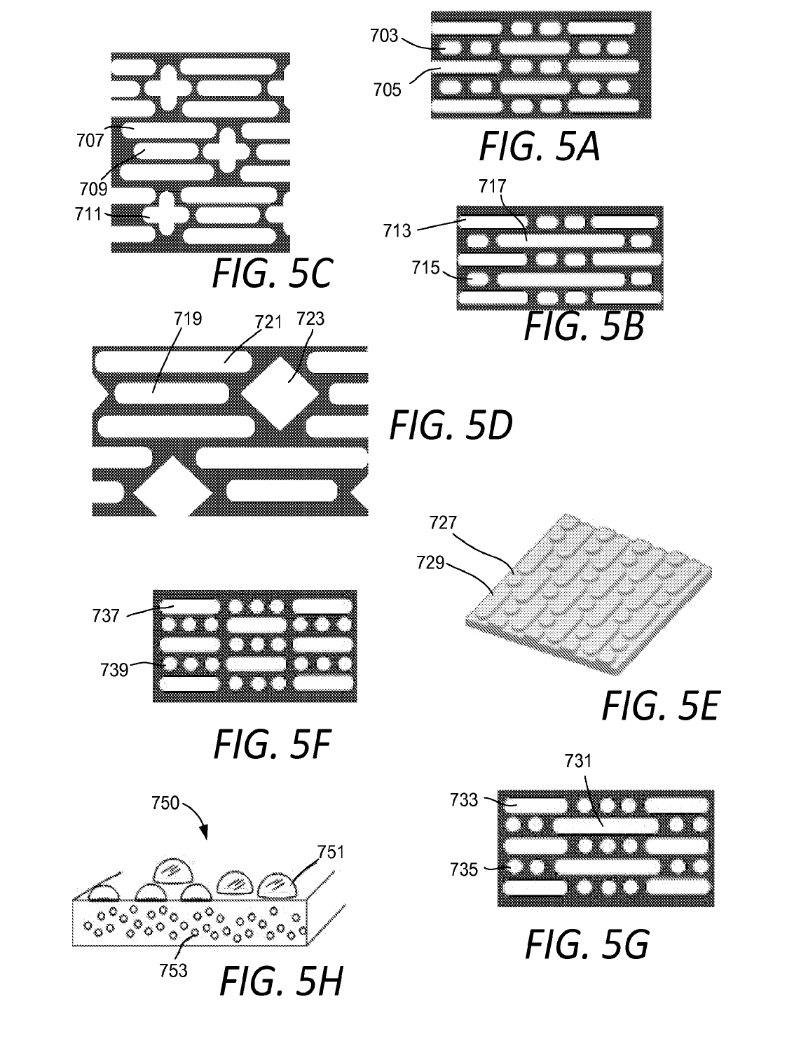

As used herein, the term “protrusion” as it relates to the embossed pattern of the present disclosure, is inclusive of any geometrical shape. For example, a protrusion can be at least a portion of a polygonal-shape, an oval shape, a cylindrical shape, a bubble-like shape, or a combination of non-isolated shapes forming a single shape. As used herein, the phrases “first protrusion and second protrusion,” or “at least two protrusions” are intended to refer to separate and isolated protrusions unless otherwise stated. A single, cross-like protrusion, as depicted in FIG. 5C, for example, is a single protrusion and not a first or second protrusion or at least two protrusions.

As used in the specification and claims, the forms “a”, “an” and “the” include singular as well as plural references unless the context clearly dictates otherwise. For example, the term “a polyolefin” includes one or more polyolefin resins, and the term “polyolefins” includes one polyolefin resin as well as more than one type of polyolefin resin.

As used herein, the term “or” means one or a combination of two or more of the listed choices.

Further, as used herein, the term “comprising” is intended to mean that the polymeric foam and processes disclosed herein include the recited elements, but does not exclude others. For example, when referring to foam comprising a chemically cross-linked polyolefin, the foam may as well include other additives, such as a dye and/or cork particles. Similarly, “consisting essentially of” is used to define foams and processes that include the recited elements but exclude other elements that may have an essential significance on the functionality of the resulting sheet. For example, a foam consisting essentially of cross-linked polyolefin will not include or will include only insignificant amounts (amounts that will have an insignificant effect on physical properties of the foam) of other elements. “Consisting of” shall mean excluding more than trace amounts of other elements. Embodiments defined by each of these transition terms are within the scope disclosed herein.

Further, all numerical values, e.g., concentration or parts per hundred parts resin (PHR) or ranges thereof, are approximations which are varied (+) or (−) by up to 20%, at times by up to 10%, from the stated values. It is to be understood, even if not always explicitly stated that all numerical designations are preceded by the term “about”. It also is to be understood, although not always explicitly stated, that the reagents described herein are merely exemplary and that equivalents of such are known in the art.

The term “chemically crosslinked” in the context of the present disclosure is used to denote that the polymer chains are inter-connected by a plurality of covalent bonds and that the covalent bonds are stable mechanically and thermally. The term “chemically crosslinked” encompasses peroxide or azo cross-linking, silane-cross-linking, high-energy cross-linking (e.g., e-beam, gamma, UV), and is used to distinguish the present disclosure from other possible forms of cross-linked polymers, including physical crosslinking. The extent of such cross-linking can be determined with conventional methods, such as solvent swelling. In one aspect, the extent of crosslinking of the presently disclosed underlay is about 50 to about 90% as measured by solvent swelling techniques. The extent of crosslinking can be targeted to achieve a desired foam density and/or foam cell size and distribution as well as control embossing parameters for the foam sheet.

The polymeric foam according to the present disclosure comprises closed-cell polymeric foam. The term “closed cell”, in contrast to “open cell”, is known to a skilled person and means that essentially all cell walls of the foam are undamaged. Preferably, at least 90% of the cells have undamaged cell walls, more preferably at least 95%, even more preferably more than 98%.

In accordance with an embodiment of the invention, the closed cell's average diameter is between 50 micron and 5000 micron, preferably between 500 micron and 3500 micron, even more preferably between 750 micron and 2500 micron.

The term “blowing agent” is known in the art and refers to any substance which alone or in combination with other substances is capable of producing a cellular structure in a polymeric or other material. Blowing agents may include compressed gases that expand when pressure is released, soluble solids that leave pores when leached out, liquids that develop cells when they change to gases, and chemical agents that decompose or react under the influence of heat to form a gas. Chemical blowing agents range from simple salts such as ammonium or sodium bicarbonate to complex nitrogen releasing agents. Blowing agents can be endothermic or exothermic.

The polymeric sheet can be foamed or un-foamed. The polymeric sheet can be a thermoplastic, thermoplastic elastomer, or composite or alloys. The polymeric sheet can comprises at least one polyolefin. As appreciated by those versed in chemistry, “polyolefins” are a class of organic substances prepared by the addition polymerization of alkene (hydrocarbons containing at least one carbon-carbon double bond per molecule), especially ethylene and propylene. The polymeric sheet of the present invention can employ one or more polyolefins, and the one or more polyolefins may be combined with one or more other polymers. Thermoplastic elastomers and alloys (e.g. thermoplastic vulcanizates such as SANTOPRENE™) include polyolefin-based (EPDM), styrene-butadiene-styrene-, styrene-isoprene-styrene-, styrene-butadiene-, and styrene-isoprene elastomers, reaction-injection molded (RIM) rubbers of silicone etc. Pre-vucanized thermosets can also be used.

In accordance with one embodiment disclosed herein, the polymeric sheet is at least partially cross-linked and foamed. The forming part of the polymeric foam is characterized by a melt index of the raw material, namely, the polymer in its melt form prior to being chemically cross-linked with the same or another polymer, of between 0.3 and 20, preferably between 0.7 and 5. Other melt index ranges can be used suitable for the polymer chosen.

In one aspect, the polymeric sheet is a polyolefin. The polyolefin may be a homopolymer or a copolymer of any C₂ to C₂₀ olefin. In accordance with one embodiment, the polyolefin is a copolymer of ethylene and an alpha-olefin selected from of iso-propene, butene, iso-pentene, hexane, iso-heptene and octane. An example of such a copolymer includes, e.g., a metallocene polyolefin, such as Engage™ (ExxonMobil).

There are a variety of polyolefins which exhibit the above melt index and thus may be used to form the polymeric foam disclosed herein. A non-limiting list of possible polyolefins comprises high density polyethylene (HDPE), Medium density PE (MDPE), low density PE (LDPE), linear low density PE (LLDPE), Metallocene PE, Poly-1,2-butadiene, ethylene propylene copolymer, ethylene butane copolymer, ethylene vinyl acetate (EVA) polymers, copolymers of ethylene with up to 45% of methyl, ethyl, propyl or butyl acrylates or methacrylates, chlorinated products of the above homopolymers or copolymers having chlorine content of up to 60% by weight and mixtures of two or more of the above mentioned polymers.

Polyolefins for chemical cross-linking to form polymeric foams are readily available in the market. For example, polyolefins may be purchased from Carmel Olefins, ExxonMobil, Borealis, Dow, Dupont, Equistar, Mitsui Chemicals, Sabic etc.

According to one preferred embodiment, the at least one polyolefin is LDPE with a melt index of 0.7-4.

The polymeric sheet disclosed herein may further comprise cork particles, or other fillers (natural or synthetic). In one aspect, an embossed, at least partially cross-linked polymeric foam sheet comprising a predetermined amount of cork particles is provided having a particular appearance. As appreciated by those versed in the art, cork is a unique material in that it is made of air-filled, watertight cells which make the cork an effective, light in weight, insulating medium. The term “cork particles” denotes naturally occurring as well as recycled cork. The cork particles may have a common, regular shape, although preferably have irregular shapes. The irregular shape may be obtained by the chopping or dicing of larger cork pieces to form cork chips, pellets, granules etc. In accordance with one embodiment, the cork particles have an average diameter of between about 100 micron and 3000 micron, preferably between 500 micron and 2000 micron. Cork material is readily available in the market and can be purchased, for example from Bet Hashaum/Amorim group (Israel).

In accordance with an embodiment, cork particles can be added to the polymer prior to cross linking, foaming, and embossing, at an amount of between about 0.1 to about 25 parts per hundred parts (PHR), or preferably 1-15 PHR or even more preferably 2.5-10 PHR, of the total amount of polyolefin present in the polymeric foam. Other concentrations may be used provided that the amount of cork does not materially affect the embossing structure, function, resiliency, or combination thereof. For example, the amount and/or particle size of the cork can effect the visual appearance of the produced sheet, e.g., perforations, cracks, holes, etc.

The polymeric sheet is generally desired to be essentially free of visible perforations, however, some level of visual imperfection can be tolerated providing it does not materially affect the embossing structure, function, resiliency, or combination thereof. It is well appreciated by those versed in the art, that porous foams having cracks, holes or any other form of perforation would derogate the quality of the foam in terms of sealing and moisture barrier, when the latter is required.

The term “essentially free of visible perforations” is intended to denote that a person versed in the art of polymeric foams, using merely his eye vision (namely, without the use of magnifying equipment), will not detect significant defects, such as perforations, cracks or holes in more than 0.1% per surface area (e.g. 1 cm²/1 m²) of the foam when in the form of a sheet, and more preferably, not at all.

The embossed polymeric sheet disclosed herein has the advantage that it may be produced as a continuous sheet, without exhibiting the aforementioned perforations and other defects typically encountered when attempting to manufacture continuous sheets of polymeric materials. The polymeric sheet is producible at a thickness of between 2 mm-20 mm and at any length above 2 m. In one aspect, the embossed polymeric sheet is at least partially crosslinked. In another aspect, the embossed polymeric sheet is foamed. In yet another aspect, the embossed polymeric sheet is at least partially cross-linked and then foamed. In combination with one or more of cross-linking and foaming, the polymeric sheet is embossed.

In addition to the above-mentioned characteristics, the embossed polymeric sheet disclosed herein may be characterized by one or more of the following properties:

it has a compression set under constant force in air of between 5 and 50% measured after 24 hrs;

it has a tensile strength of between 50 and 80 p.s.i.;

it has an elongation at break of between 30 and 500%;

it has a compressive stress (deflection at 25%) of between 2 and 20 p.s.i.; and/or

it has a compressive stress (deflection at 50%) of between 5 and 40 p.s.i.

The polymeric composition used to form the embossed sheet disclosed herein may comprise additives typically used in polymer industry. Such additives may include, with out being limited thereto, one or more of a dye, such as a color masterbatch; a stiffener, such as high-density polyethylene HDPE; a softener such as EVA; an antioxidant such as BHT; an anti-fungal such as nano silver particles; an anti-static such as GMS; ultra violet resistant additives; an inorganic filler, such as Calcium Carbonate; an organic filler, such as Corn starch or cellulosic material; a chemical blowing agent (an agent that alone or in combination with other substances is capable of producing a cellular structure in a polymer) such as azodicarbonamide; a co-activator of the chemical blowing agent (catalyst or activator of the foaming agents to lower temperatures) such as zinc oxide; a conducting agent, such as Conductive carbon black, a halogenated flame retardant agent, such as dibromodiphenyl ether or a non halogenated flame retardant such as magnesium hydroxide, a silanol condensation catalyst, etc.

The embossed polymeric sheet disclosed herein may have various applications as discussed above. In accordance with one embodiment, the embossed polymeric sheet disclosed herein is used as underlayment with soft and hard flooring surfaces, e.g. wood floors and/or carpeting (residential or commercial) or other floor covering, e.g., tile carpeting laminate flooring, wood flooring, floating floors, peel-and-stick flooring, etc. In addition, the sheet disclosed herein can also be used with stone flooring surfaces such as ceramic, etc., as ballast mats in Railway track applications that lower vibration and sound development, midsoles in shoe manufacture, acoustic and heat insulation panels in automotive applications, fashion accessories (bags, belts etc.), anti-fatigue mats, Office notice boards etc.

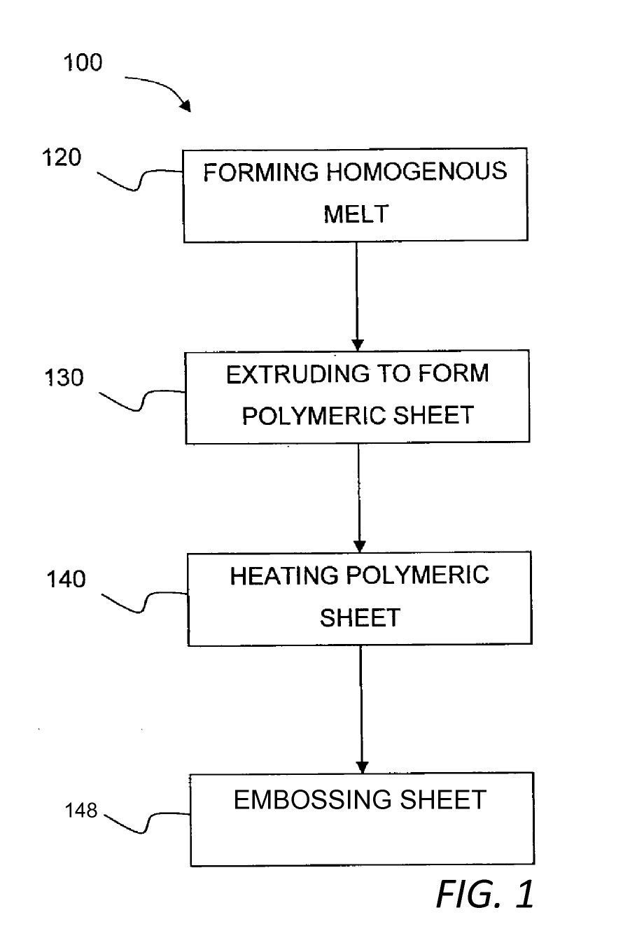

Reference is now made to FIG. 1 which provides a schematic block diagram 100 of the main steps for manufacturing a continuous sheet comprising an exemplary at least partially cross-linked, foamed polymeric sheet, as described above. The cross-linking and foaming being in one aspect, optional. It is noted that while FIG. 1 is described as a step-wise process, the process is not a batch process, but rather a continuous process, where each step is continuously operated, thereby allowing the formation of a continuous sheet. In one aspect, the entire process is continuous, including the embossing. In another aspect, the embossing can be performed as a separate process as disclosed and described herein.

Firstly, in Step 120 starting (raw) materials comprising at least one polyolefin resin, optionally, at least one cross-linking agent, and optionally, at least one blowing agent, are continuously fed into a mixing arrangement set at a temperature of between 60° C. and 200° C. to form a homogeneous molten blend (at times referred to by the term “homogenous melt”).

The homogenous melt is fed into an extrusion line (Step 130) constructed to form from said homogenous melt a continuous polymeric sheet. The continuous polymeric sheet is then optionally transferred into a heating module (Step 140) for heating the continuous sheet to a first temperature at which cross-linking of the at least one polyolefin resin can be performed, albeit being lower than the temperature required for activating the blowing agent. In at least one aspect, a cross-linking agent is used, and as a result, a cross-linked polyolefin sheet is obtained as depicted in Step 130.

Step 140 optionally comprises elevating the temperature within the heating module or in a separate oven, thereby further heating the polymer sheet (or cross-linked sheet) to a second temperature at which the optional blowing agent present in the melt can be activated. In at least one aspect, a blowing agent is used and as a result, a continuous, foamed polymeric sheet is obtained. in yet another aspect, a cross-linking agent is used and a blowing agent is used, and as a result, a continuous, at least partially cross-linked, foamed polymeric sheet is obtained. Alternatively, either the cross-linking or the foaming can be done after the sheet is fabricated, for example., high energy cross-linking means (e.g., e-beam) and/or physical foaming (by gas) means.

Step 148 provides for the continuous polymeric sheet of to be embossed, e.g., to provide a pattern on one or both longitudinal surfaces. In one aspect, embossing is performed on the at least partially cross-linked polymeric sheet. In another aspect, embossing is performed on the foamed sheet. And in another aspect, embossing is performed on the at least partially cross-linked, foamed polymeric sheet. Additional steps optionally may be performed, such as lamination and/or where the sheet is processed for storage (not shown). Processing may include rolling the continuous sheet, cutting from the continuous sheet pre-designed blocks etc.

In accordance with a first embodiment, in Step 120 the raw material comprises also one or more additives selected from a dye, a stiffener, a softener, a plasticizer, an antioxidant, an anti-fungal, an anti-static, an ultra violet resistant additive, an inorganic filler, an organic filler, a chemical blowing agent kicker, a conducting agent, and a flame retardant agent, as will be further discussed below.

In Step 120 the raw materials are mixed at a temperature of between about 60° C. and about 200° C. and more specifically, from about 80° C. to about 150° C., so as to allow the formation of a molten blend in which the various constituents are homogenously dispersed in the blend.

The homogenous melt may be obtained by using a variety of mixers known in the polymer industry. Some exemplary, non-limiting mixers include a Banbury mixer, a dispersion mixer, a batch mixer, an internal Mixer, a kneader and others.

As appreciated by those versed in the art, mixing in the mixer may take from about several seconds to about several minutes until the homogenous molten blend is obtained. Once ready, the homogenous melt obtained from Step 120 is transferred, in Step 130, via, e.g. a feed hopper, into an extrusion line.

A typical extrusion line may consist of the raw material feed hopper, a single extruder or a combination of extruders connected in a series, an extrusion die, a calibration unit, and haul-off. The extruders typically comprise a heated barrel containing therein a single or plurality of rotating screws. The extrusion line may include a single extruder or combinations of extruders which may be any one of the extruders known in the polymer industry, including, without being limited thereto, single screw extruder, tapered twin extruder, tapered twin single extruder, twin screw extruder, multi-screw extruder. The extrusion line may also comprise a sheet pre-forming machine. The melt moves from the back of the screw to the head of extrusion die channel in which the melt is simultaneously heated, mixed and pressurized to take up an approximate shape of a sheet.

As appreciated by those versed in the art, the extruder or series of extruders has the following basic functions: it compresses the melt while at the same time allowing removal of volatile gases (optionally removed by vacuum), it softens the melt by heating it (both from internally generated shear forces and additional externally applied heat, if used), it mixes the melt and produces a homogenous melt without impurities, it meters the melt into the die area, and it applies a constant pressure required to force the melt through the die.

The die may be any type of die known in the art, including, without being limited thereto, T-die, strand die, Flat die/Coathanger die etc. The die output may then be transferred into one or more calender rolls for smoothing the surface of the polymeric sheet and/or pressing it to obtain a substantially predetermined uniform thickness throughout the polymeric sheet. In one aspect, as long as the melt is continuously fed from the hopper into the extruder, a continuous sheet of a uniform thickness exits the extruder and can be subsequently fed to a calender, as described above, to obtain a substantially predetermined uniform thickness throughout the polymeric sheet. Calendering rolls can be employed to increase the width of the sheet and/or precisely control the thickness of the sheet. One or more calendering operations can be performed through out the process as desired.

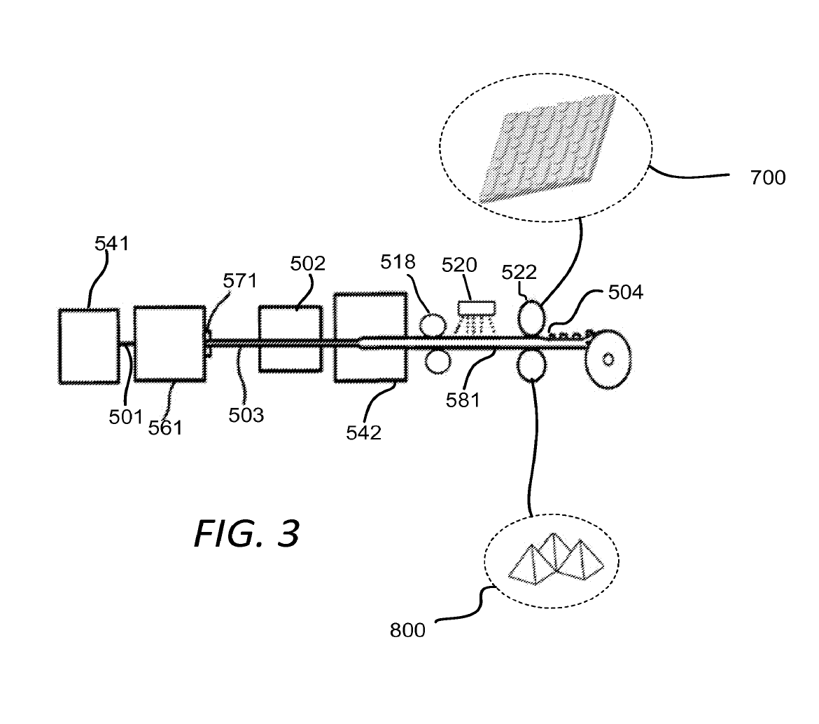

In one aspect, when the crosslinking agent is employed, the continuous sheet is transferred to a heating arrangement (Step 140) comprising a cross-linking module (shown in FIG. 3) in which the chemical cross-linking is initiated. When a blowing agent is used in combination with the cross-linking agent, the at least partially cross-linked sheet is continuously introduced into a blowing module (not shown in FIG. 3) in which the blowing agent is activated resulting in the at least partially chemically cross-linked foamed polymeric sheet. The sheet may be cooled or heated between the cross-linking module and the blowing module, e.g., chill/hot rolls, serpentine rollers, etc. Heating in either module can be via conduction, convection, or infra-red means conventionally employed in the art.

The cross-linking module comprises a conveyer oven adapted to heat the continuous sheet to a first temperature which permits being lower than that required for activating the blowing agent, if included a priori in the raw blend.

According to one embodiment, the conveyer oven is a horizontal oven typically of a length of 10-50 m, however, other lengths can be used. The oven is equipped with a moving belt (e.g. stainless steel belt) which slowly transports the sheet at a temperature range which induces either cross-linking or blowing or both (in two distinct sections). According to one embodiment, the temperature range (the said first temperature) is between about 70° C. and about 160° C. so as to activate and induce cross-linking. It is noted that the oven can have a fixed temperature or a temperature gradient. The belt transports the sheet at a speed that is variable and is determined upon by the density and thickness of the foam to be produced

A variety of cross-linking agents may be included in the melt, so as to allow cross-linking of the at least one polyolefin in the melt. Typically used to this end are peroxides (compounds containing an oxygen-oxygen single bond). A non-limiting list of peroxide-based cross-linking agents comprises dicumyl peroxide, di-t-butyl peroxide, 2,5-dimethyl-2,5-di(t-butylperoxy)hexane, 2,5-dimethyl-2,5-di(t-butylperoxy)hexyne-3,1,3-bis(t-butylperoxyisopropyl)benzene, 1,1-bis(t-butylperoxy)-3,3,5-trimethylcyclohexane, n-butyl-4,4-bis(t-butylperoxy)valerate, benzoyl peroxide, p-chlorobenzoyl peroxide, 2,4-dichlorobenzoyl peroxide, t-butyl peroxybenzoate, t-butyl perbenzoate, t-butyl peroxyisopropyl carbonate, diacetyl peroxide, lauroyl peroxide and t-butyl cumyl peroxide.

In one aspect, a peroxide based cross-linking agent in accordance with the present disclosure is dicumyl peroxide.

The cross-linking agent may also be an organosilane linker and a silanol condensation catalyst. For example, the one step “Monosil” process can be used, or alternatively, the two step “Sioplas” technology can be employed. For those knowledgeable in the art, either method can be utilized to produce silane-crosslinked polyolefinic foams.

The blowing module, e.g., for creating the voids in the polymer, may constitute a second conveyer oven or a second portion of the conveyer in which cross-linking has occurred. The blowing module is adapted to continuously receive and to heat the sheet (cross-linked or non-cross-linked) to a second temperature capable of activating the blowing agent. The second temperature is typically higher than that required for cross-linking so as to avoid foaming during the cross-linking process. Typically, the second temperature, according to one embodiment, is between about 150° C. and 250° C.

The blowing agent in one aspect is a chemical blowing agent. A non-limiting list of chemical blowing agents comprise azodicarbonamide, barium azodicarboxylate, azobisisobutyronitrile, and azodicarboxylic amide, nitroso compounds, such as N,N′-dinitrosopentamethylenetetramine, N,N′-dimethyl-N,N′-dinitrosoterephthalamide, and trinitrotrimethyltriamine, hydrazide compounds, such as 4,4′-oxybis(benzenesulfonylhydrazide), paratoluenesulfonylhydrazide, diphenylsulfone-3,3′-disulfonylhydrazide, and allylbis(sulfonylhydrazide), semicarbazide compounds, such as p-toluilenesulfonylsemicarbazide, and 4,4′-oxybis(benzenesulfonylsemicarbazide), alkane fluorides, such as trichloromonofluoromethane, and dichloromonofluoromethane, and triazole compounds, such as 5-morpholyl-1,2,3,4-thiatriazole. In one aspect, the blowing agent in accordance with the present disclosure is azodicarbonamide.

It is to be appreciated by those versed in the art that the cross-linking and blowing may take place in two different conveyer ovens, or in a single conveyer oven having a first section being heated to the first temperature where cross-linking takes place, either as a fixed temperature or as a gradient and a second section receiving the cross-linked polymer, and having a second temperature, either as a fixed temperature or as a gradient, where the blowing agent is activated and foaming of the cross-linked sheet takes place.

The temperatures in the two different ovens or in the two sections of a single oven and the transport velocity of the transporting belts are adjusted, so that the cross-liking process is brought to a predetermined level (e.g., completely or at least partially) before the blowing process takes place.

According to one embodiment, the cross-linking temperatures are in the region of 120° C.-150° C. During the cross-linking stage, the polymer sheet is softened, crosslinking takes place, and the melt strength goes up enough so that when, towards the end of the oven (or the first section of the oven), the temperatures can be raised up to a predetermined temperature capable of activating the blowing agent or providing a material that can be foamed. The predetermined temperature of the second oven or second section are typically greater than that of the first oven or first section. In one aspect, the predetermined temperature of the second oven or second section is over 200° C. (typically in the range of 220° C.-250° C.). At this temperature the foaming occurs and the sheet material comes out of the oven as a foam sheet.

In one aspect, after formation of the foam (e.g., after foaming is at least partially completed) the continuous sheet can be cooled by one or more chiller rolls prior to take up by one or more embossing rolls. Embossing is carried out to provide a pattern on one or both opposing surfaces of the sheet to form protrusions. In one aspect, a plurality of two or more physically separated protrusions is formed, where each of the plurality of two or more protrusions are different from each other, either in length, height, or width. The two or more protrusions can be arranged in a random, ordered, and/or repeating pattern arranged in a horizontal and/or vertical orientation on one or both of the sheet surfaces.

Embossing may be carried out by stamping or pinch rolls, said rolls having features of predetermined height, width, length, and spatial arrangement. The stamp or embossing rolls can be heated or chilled. In one aspect, the sheet is chilled and then at least a portion of one or both surfaces of the sheet are heated (e.g., flame, infra-red, conduction, friction rolls, etc). In another aspect, the polymer sheet is taken up by heated embossing rolls (e.g., oil heated or conductively heated). Additional rolls and arrangement of rollers (e.g. serpentine, etc.) can be employed for cooling and/or heating before and/or after embossing.

In one aspect, before or after embossing the sheet can be laminated. The sheet or the at least partially cross-linked, foamed, or at least partially cross-linked and foamed sheet can be laminated with one or more layers. The layers can be any one or more of a thermoplastic film, a thermoplastic elastomer film, water vapor barrier film, adhesive layer such as a pressure sensitive or peel-and-stick adhesive, a cork-filled polymer sheet, a soft or hard flooring material, and an open cell foamed sheet. Lamination can be performed using conventional techniques, including, but not limited to, heated rolls, pinch rolls, and the like. The lamination can utilize existing rolls of the continuous process or be carried out on a dedicated processing line.

After embossing, the sheet can be cooled and processed for storage (e.g. rolling, cutting etc.). According to one embodiment, cooling is achieved using a sheet Haul-off (Winder) system. A sheet Haul-off system may comprise two main sections. A first cooling section and a second Winding section. According to another embodiment, cooling may be achieved by water chilling. It is preferable that cooling is performed as quickly as possible, to a temperature below 100° C. As soon as the foam is cooled enough, it is wound.

The continuous rolled sheet may be aged for a sufficient period of time for optimal annealing and relaxation before performing further processing such as welding, laminating of materials etc. as further described below with reference to the different applications of the continuous rolled sheet. It is noted that instead of rolling, the continuous polymeric foamed sheet exiting the conveying oven may be cooled and sliced into blocks or sheets (or rolls) of fixed length for storage.

A variety of combinations of raw materials may be used to form the continuous sheet of embossed, c polymeric sheet in accordance with the present disclosure. In an exemplary embodiment, a continuous sheet of at least partially cross-linked foamed polymer is prepared using materials comprising a mixture of at least one polyolefin resin, 0.2-25 PHR (preferably 2-20, more preferable, 5-15) of chemical blowing agent blowing agent, 0.1-2 PHR (preferably 0.4-1.2) of a cross-linking agent, and 0-3 PHR (preferably 0.1-1) of a dye (color Masterbatch would be better). In one aspect, 0.1-25 parts by weight per hundred parts (PHR) (preferably 1-15, more preferably 2.5-10) of cork particles can be added. If cork particles are used, in one aspect, the raw material comprises 2.5-10 PHR cork particles.

In accordance with the same or other embodiments, the raw materials may comprise 5-15 PHR of chemical blowing agent. Alone or in combination with the chemical blowing agent, the raw materials may comprise 0.4-1.2 PHR of a cross-linking agent.

It is noted that while the above example (referring to FIG. 1) includes the addition of cross-linking agent and a blowing agent, the cross-linking as well as the blowing so as to form a crosslinked polyolefin foam may be achieved without the said cross-linking agent and/or blowing agent. For example, cross-linking and blowing may be obtained physically as described by Alveo or by Zotefoams, respectively. For example, using high energy radiation for cross-linking and/or gas for foaming after the sheet is formed.

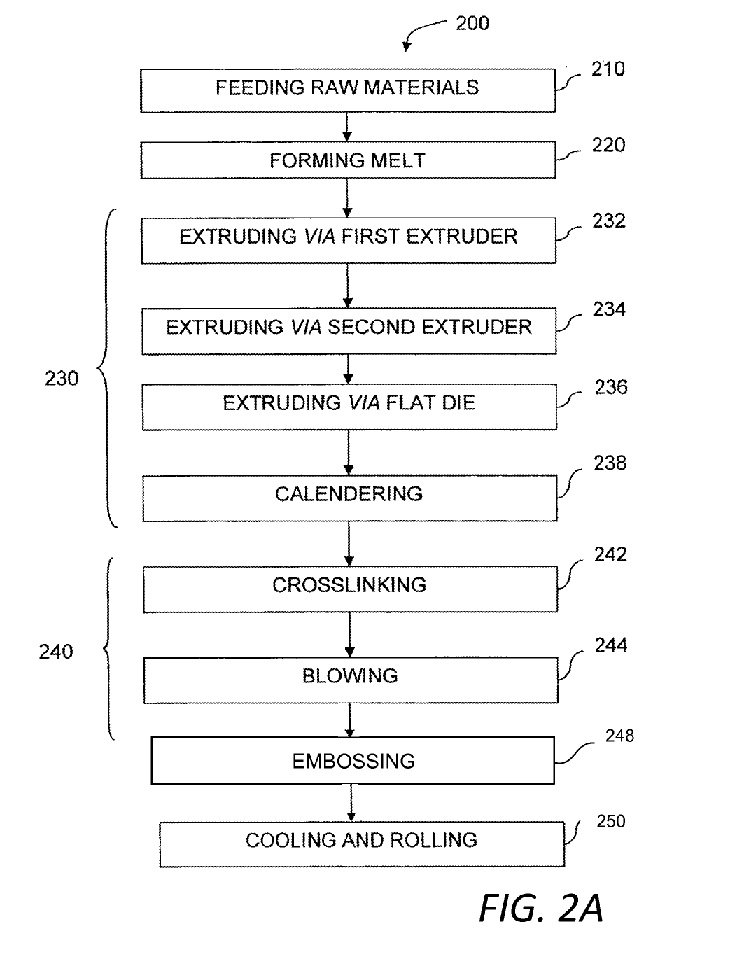

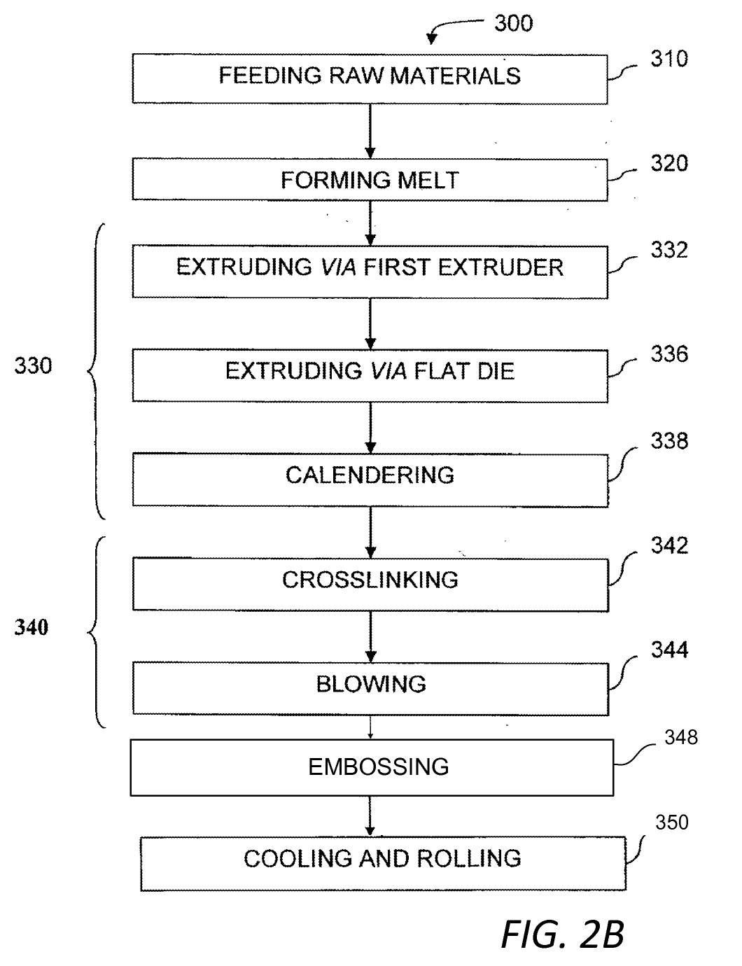

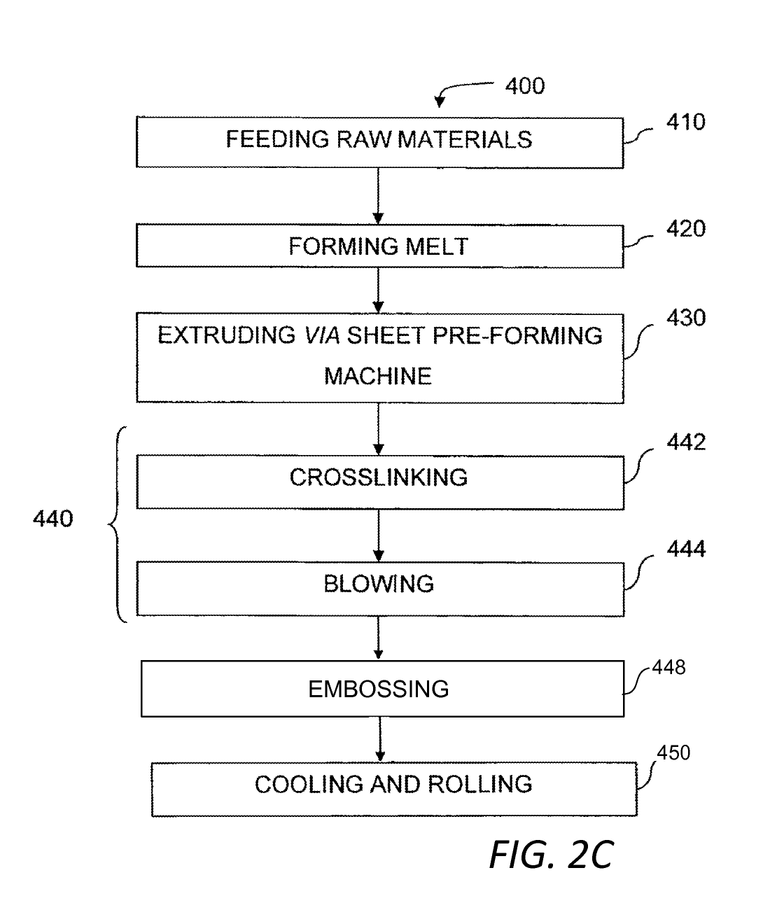

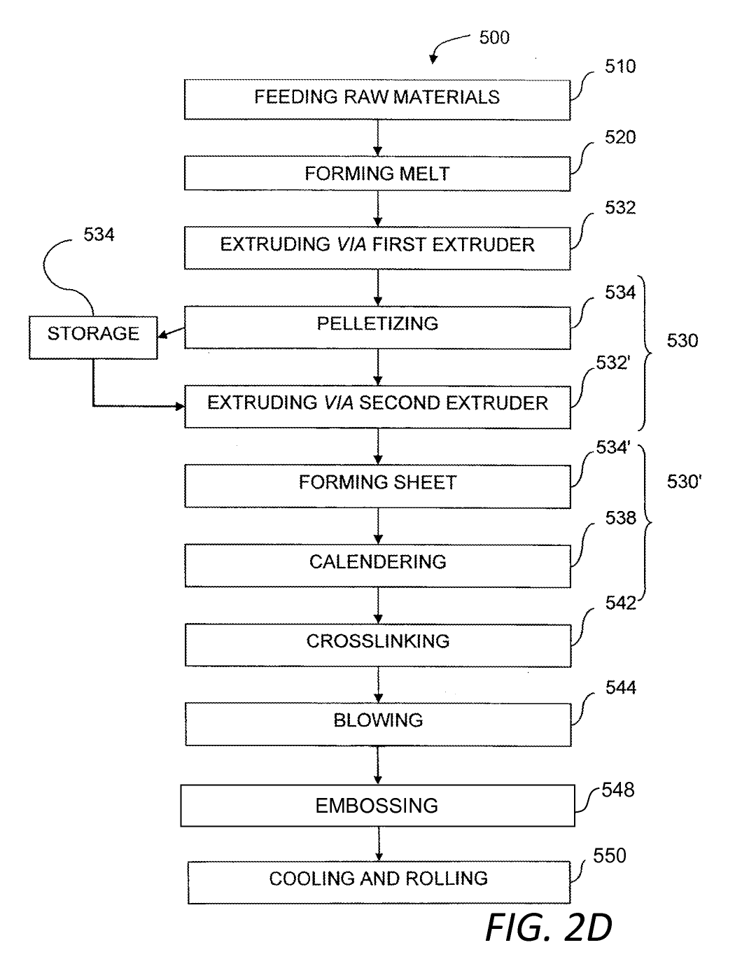

Reference is now made to FIGS. 2A-2D which are schematic illustrations of alternative steps for performing the process for producing a chemically cross-linked polyolefin based embossed foam. For simplicity, like reference numerals to those used in FIG. 1, shifted by 100 are used to identify components having a similar function in FIGS. 2A-2D. For example, Step 120 in FIG. 1, which relates to the formation of a melt, is referred to as Step 220 in FIG. 2A, 320 in FIG. 2B, 420 in FIG. 2D and so forth.

Specifically, FIG. 2A illustrates a process 200 where firstly the mixture of raw materials comprising at minimum at least one polyolefin resin, a cross-linking agent and a blowing agent is fed into a mixer (Step 210). The mixer may be any commercial mixer available in the industry, some examples of same provided hereinabove. The mixer (210) includes, in addition to the at least one polyolefin, the blowing agent and a radical generator such as a peroxide.

The mixer is also configured to convey heat at a temperature of between about 80° C. to and about 150° C. Thus, while being continuously mixed, the raw materials melt (Step 220) while they are homogenized into a molten blend.

Once an essentially homogeneous melt is obtained and the temperature of the melt and the mixer inner chamber are essentially the same (although these criteria may vary, depending on the raw materials used), the melt is transferred (fed) into an extrusion line comprising a series of extruders in fluid communication. Accordingly, the homogeneous melt is firstly pressed into the inlet of a first extruder, being in this particular embodiment a tapered twin screw extruder (Step 232), is set to exert heat onto the melt received and contained therein at a temperature of between about 80° C. to about 200° C.

The molten blend is then extruded via the outlet of the tapered twin screw extruder directly into the inlet of a second extruder, in this particular embodiment, a single screw extruder (Step 234) the outlet of which is connected to the inlet of a flat die (Step 236). The molten blend extruded through the flat die is in the form of a continuous sheet.

The continuous sheet is then continuously fed into a triple roll calender (Step 238) which can provide a predetermined sheet thickness. One or more calendars can be used to smooth one or both surfaces of the sheet and/or provide sheets with a uniform, pre-determined thickness.

The uniformly produced continuous sheet exiting the calendar is transferred to a conveyer oven (Step 240) having a first section (Step 242) which is set at a temperature sufficient for completing crosslinking of the polymers in the continuous sheet, and following in line, a second section (Step 244), which is set at a temperature sufficient for activating the blowing agent and blowing the received, chemically cross-linked polymeric sheet, to obtain the respective foamed sheet which is then embossed (Step 248) as described below. The sheet can then be cooled and processed for storage (Step 250). According to this embodiment, cooling is achieved on chiller rolls and the cooled continuous sheet is then wound on a core

Reference is now made to FIG. 2B which illustrates a process 300, with essentially the same steps as illustrated in FIG. 2A, with the main difference that the process illustrated in FIG. 2B is missing in the respective Step 234 the use of a single screw extruder just after the tapered twin screw extruder. In other words, the essentially homogeneous melt existing the mixer is fed into an extrusion line comprising a tapered twin single extruder (Step 332), set to exert heat onto the molten received and contained therein at a temperature of between about 80° C. to about 200° C. The resulting blend is then directly fed into the inlet of a flat die (Step 336). Step 340 (e.g., comprising steps 338, 342), and step 348 and 350 are similar to that described above for FIG. 2A.

Reference is now made to FIG. 2C which illustrates a process 400, with essentially the same steps as illustrated in FIG. 2A, albeit with the difference that a sheet pre-forming machine is utilized in Step 430 to form a sheet of uniform thickness. Sheet pre-forming machines are well known in the art, and as an example, a sheet pre-forming machine as described by Moriyama Company Ltd. may be employed, with reference to the following website address: [http://www.ms-moriyama.co.jp/english/products/e_sheet_index.html]. The sheet pre-forming machine is comprised essentially of a tapered twin screw connected to mixer rolls. According to this particular embodiment, homogenized melt received from the mixer (from Step 420) is introduced initially into the tapered twin screw, set at a temperature of between about 80° C.-200° C., from which the melt is transferred into the mixer rolls to produce the polymeric sheet ready for heating (Step 440), embossing (Step 448), and processing (Step 450).

Reference is now made to FIG. 2D which schematically illustrates a process 500 similar to the process of FIG. 2A, however, comprising an extrusion line which allows the formation of pellets from the homogenous melt. Specifically, following the formation of a melt comprising a homogeneous mixture of the raw materials (Steps 510, 520), the melt is extruded in a first extrusion line (Step 532) comprising a first extruder (Step 532), connected via its outlet to a pelletizing die allowing the formation of pellets comprising the homogenously mixed raw materials (Step 534). In this particular embodiment the first extrusion line comprises, respectively, a tapered twin single extruder (or into a combination in line of a tapered twin screw extruder followed by a single screw extruder) and “strands” forming die. The thus formed pellets may then be collected and stored (Step 560) for future return into the process (Step 570), or directly fed into a second extrusion line (Step 530′). In the second extrusion line, comprising a second extruder connected in line to a die, the pellets are received and thereby extruded to obtain thereby a sheet of uniform thickness (Steps 532′ and 534′). In this specific embodiment, the pellets are fed into a single or twin screw extruder (Step 532′) followed by extrusion via a flat die (Step 534′) for forming the sheet. The sheet is then further processed through a calendar and so forth, (Steps 538, 542, 544, 548, and 550) as detailed in connection with FIG. 2A, until the embossed, continuous sheet of chemically cross-linked polymeric foam is obtained.

Reference is now made to FIG. 3 which shows an exemplary extrusion similar to that of FIG. 1, where material is added to mixer 541 to provide blended raw material 501 to extruder 561, The polymeric material 12 is then passed to an extruder 16 that forms a continuously extruded sheet 503. FIG. 3 depicts an extruded sheet 503 that is a generally planar, continuous sheet, but other extruded shapes may be formed using the method of the present disclosure. The continuous sheet will typically have an uncured, unfoamed predetermined thickness that may range from about 1 millimeter to about 6 millimeter or thicker. Extruder 561 is shown with sheet die 571 for directly extruding the continuous sheet. Other dies can be used, e.g., for extruding a continuous sleeve having a uniform annular wall thickness. If a sleeve die is used, the continuous sheet may be formed by cutting through the sleeve wall immediately following the extrusion of the sleeve. Such an extruded form can then be flattened to form a continuous sheet.

Sheet 503 is passed to a first oven or first section 502 for activation of the cross-linking agent, if one is used. Alternatively, an e-beam or other high energy source can be used. Alternatively, if silane-grafted polyolefin is used, promotion of cross-linking by introducing the silane and catalyst into the melt or at die 571. Sheet 503 then exits first oven 502 and, if a blowing agent is employed, enters second oven or second section 542 having a higher temperature than first oven 502. Foaming of the sheet occurs and foamed sheet 581 of greater thickness than sheet 503 exits second oven 542. Optionally, calender rolls can be employed to adjust the thickness and/or width of sheet 581. Chiller rolls 518 take up and cool sheet allowing sheet to at least partially set. In one aspect, prior to embossing sheet 581, it is heated via heater 502. Heater 520 can, for example, be an infra-red heater, flame, or electric heater. In one aspect, the surface of cooled sheet 581 is heated prior to take up by embossing roll 522. Heater 520 can be configured and arranged to heat preferentially the surface of sheet 581 prior to being taken up by embossing station.

Sheet 581 is taken up by an embossing means where one or more embossing rollers 522 are used to impress a three dimensional pattern into a surface of the sheet 581. Roller 522 is held in engagement with at least one surface of sheet 581 with sufficient pressure that the pattern on the engraving roller causes a corresponding first embossed pattern 700 in the surface of the cured, foamed sheet. This pattern is repeated for each revolution of the roller. If the pattern is to be applied to only a single surface of a sheet-like extrudate, one roller will be an engraving roller and the other will typically be a flat back-up roller. Alternatively, as shown, foamed sheet 581 is passed between two rollers, each roller having a different embossing pattern to emboss a second embossed pattern 800 into the opposite surface of the sheet. Embossing can include sequentially staged or serpentined roller pairs or a plurality of single rollers for impressing patterns on multiple surfaces or for impressing multiple patterns on a single surface. The protrusions made by the engraving roller may have straight or curved walls/edges and may also be tapered. Embossed sheet 504 is then taken up for storage.

Embossing roll(s) 522 can be heated or cooled, depending on the temperature of sheet 581 prior to take up. In one aspect, sheet 581 is heated, e.g., via heater 520, to provide for higher aspect ratio (height/width) of protrusions formed in sheet than otherwise obtainable with a cold sheet/hot embossing roll configuration. Embossing roll 522 can be hollow, and can be provided with a plurality of openings extending from the surface to the interior of roll 522 to act as vents for release of gas formed during the embossing and/or allow for at least partial vacuum assisted embossing by coupling the vents to a vacuum source through the hollow embossing roll. Thus, embossing may be by pressure, solely by vacuum assisted embossing, or by a combination of vacuum and pressure.

Bubbles (open or closed cell) on one or more surfaces of sheet 581 can be prepared using conventional techniques, either using additional embossing rolls or simultaneously with the embossing of protrusions. A bubbled surface can also be prepared via lamination and vacuum assisted embossing techniques known in the art. For example, a bubbled surface can be manufactured by leading a flat polymer top film over heating roller where it is heated and then lead to an embossing roll (which may be vacuum assisted) having pockets (negative image of bubble) for forming the bubble in the top film at the drum. Polymeric sheet 581 can act as the backing film and be heat fused to the top film, either at the embossing roll or elsewhere, sealing the top film and forming a bubble sheet (not shown). Alternatively, bubbles can be formed in the surface of sheet 581 using a dedicated embossing roll.

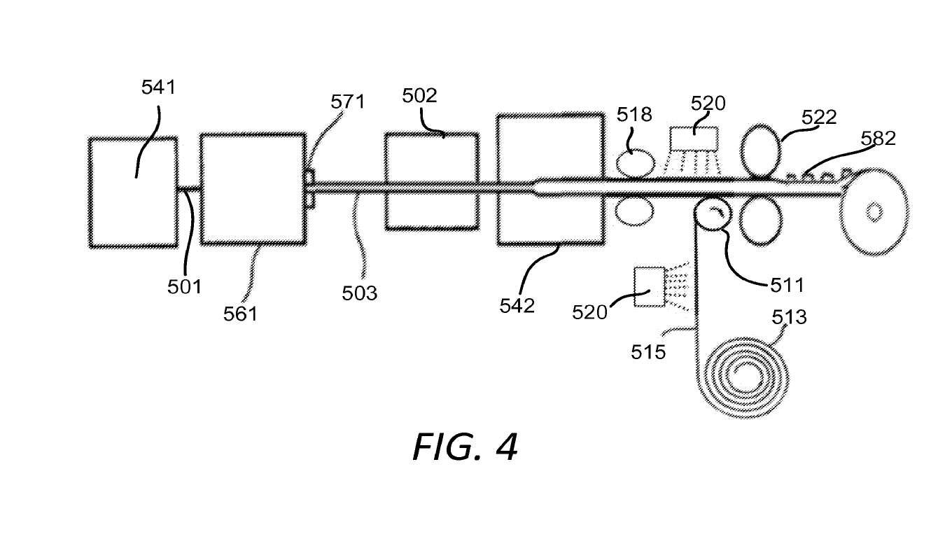

Reference is now made to FIG. 4, which is similar to that described for FIG. 3 with the additional step of including a lamination process. Thus, laminate layer 515 is pulled from roll 513 to mate with sheet 581 via nip roll 511. Laminate layer 515 can be heated via heater 520 prior to mating with sheet 581. Nip roll 511 can be heated to a predetermined temperature suitable for melt bonding of laminate layer 515 to sheet 581, or for activating an adhesive applied to the surface of layer 515. Embossed sheet 582, e.g., with laminate on one side of sheet, is then taken up for storage. Laminate layer 515 can provide a moisture/liquid permeation barrier for the underlayer sheet to protect the flooring/sub-flooring. Laminate layer 515 can be or comprise an adhesive (e.g., pressure sensitive adhesive, peel-off tape) or melt adhesive, or a water-based acrylic adhesive so as to bond to sheet 581. Laminate layer 515 can include flame retardant material, anti-microbial material, and/or fungicide. Laminate layer 515 can be a low density polyolefin, ethylene vinyl acetate, polyurethane, or the like. In one aspect, laminated layer 515 is selected from a thermoplastic film, a thermoplastic elastomer film, water vapor barrier film, adhesive layer such as a pressure sensitive or peel-and-stick adhesive, a cork-filled polymer sheet, a soft or hard flooring material, and an open cell foamed sheet. Sheet 582 with laminate layer 515 can be configured of recycled materials and/or can be of recyclable materials.

In one aspect, at least two protrusions, or, independently, a plurality of at least two protrusions on one or both surfaces of the polymeric sheet are provided. Reference is now made to FIGS. 5A-5H, which depicts various predetermined arrangements of two or more raised protrusions in the polymeric sheet surface configured to direct, impede, and/or control gas (e.g., air) movement during use of the sheet, e.g., as an underlayer, and, when not in use, maintain a passive air flow between the sub-floor and flooring. The protrusions also can prevent degradation of the integrity of the flooring and the foamed sheet itself. In one aspect, the protrusions project from the surface of the sheet about 0.5 mm to about 4 mm. In one aspect, the average spacing between the protrusions can be between 0 and about 50 millimeters. In another aspect, the protrusions project from the surface of the sheet about 1 mm to about 3 mm. In another aspect, the aspect ratio of either the first or second protrusions are about 0.01 to about 0.3.

In another aspect, the at least two protrusions are of: (a) an average height of about 1 millimeter to about 4 millimeter; (b) an average spacing there between of between 0 and about 50 millimeters; or (c) a height to width ratio (aspect ratio) of about 0.05 to about 0.4. In another aspect, the at least two protrusions are (a) or (b) in combination with (c) as defined above. Such aspect ratios and/or combinations provide for optimization directing, impeding, and/or controlling gas (e.g., air) movement during use of the flooring, and, when not in use, maintaining passive air flow between the sub-floor and flooring. The sheet can comprise a plurality of different protrusions arranged randomly or in a predetermined spatial arrangement.

Thus, FIG. 5A depicts a top plan view of a plurality of short bars 703 arranged linearly with longer bar 705. FIG. 5B depicts a first row pattern comprising a plurality of short bars 715 arranged linearly with medium length bars 713 and a second row pattern of short bars 715 and long bars 717. FIG. 5C depicts an arrangement of two long bars 707 having short bar 709 positioned between, straddling a cross-like protrusion 711, which repeats in sequential rows in an offset manner. FIG. 5D is similar to that of FIG. 5C, with an arrangement of two long bars 721 having short bar 719 positioned between, straddling a diamond-like protrusion 723, which repeats in sequential rows in an offset manner. FIG. 5E depicts a linear arrangement of long bar 729 and circular protrusion 727, which repeats in sequential rows in an offset manner FIG. 5F depicts a linear arrangement of long bar 737 and plurality of circular protrusions 739. FIG. 5G depicts a linear arrangement of short bar 733 and plurality of circular protrusions 735 in a first row, and depicts a linear arrangement of long bar 731 and plurality of circular protrusions 735 in a second row. Such arrangement of protrusions can create network of channels and/or a torturous path for gas (e.g., air) when the underlayer is compressed during use (e.g., walked upon), which can retain the gas temporarily and resist additional compression of the structure, which in turn minimizes the amount of underlayer surface in contact with the floor or sub-floor. In one aspect, the protrusions are configured to form a closed space upon compression to retain gas temporarily.

FIG. 5H depicts a foamed sheet 750 (optionally cross-linked) having closed cell foam structure 753 and a surface comprised of a plurality of bubbles 751 prepared as describe above. Bubbles 751 can be of the same material as sheet 750 or can be of a laminate of a different material.

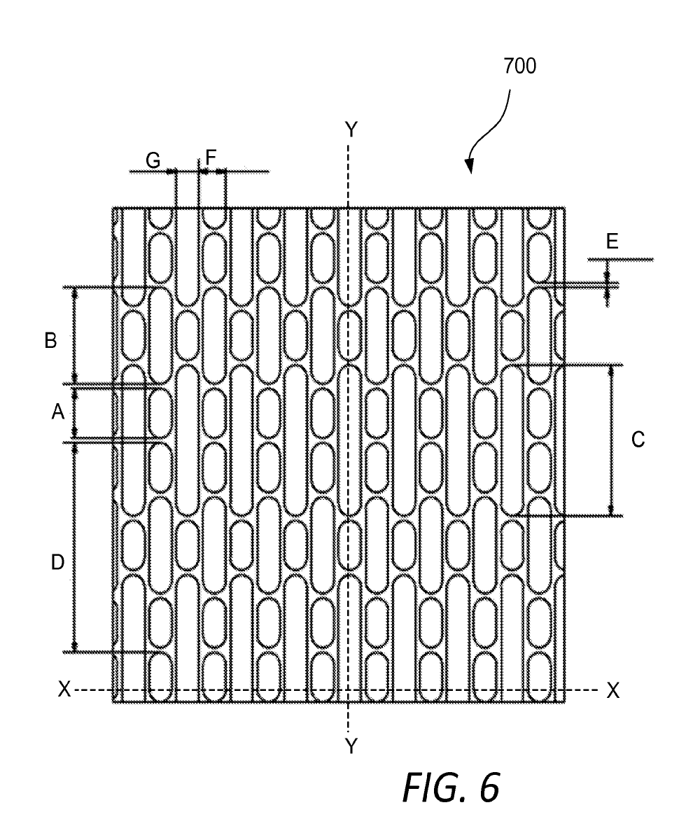

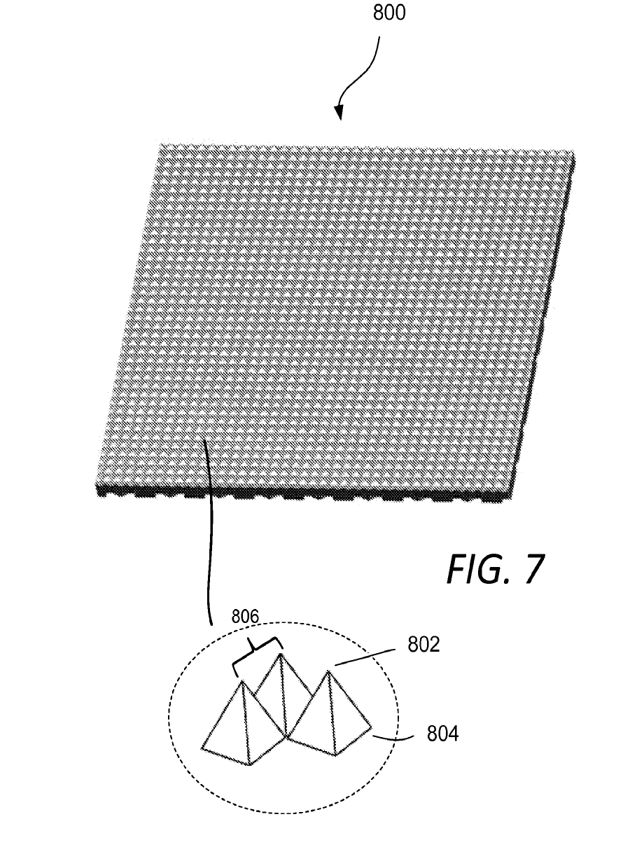

FIG. 6 depicts an exemplary embodiment of embossed pattern 700 showing the arrangement of protrusions. In one aspect as shown, at two protrusions different from each other are presented. An embossing roll having the negative three-dimensional image of pattern 700 would be used to provide the exemplary pattern 700. Such an arrangement is capable of providing the functionality in the foamed sheet surface, e.g., so as to direct, impede, and/or control gas (e.g., air) movement during use of the flooring, and, when not in use, maintain passive air flow between the sub-floor and flooring. Thus, FIG. 6 shows a linear arrangement of a first row of long and short bars and a second row having a linear arrangement of medium length bars and a plurality of short bars. Short bar having a length A of about 20 millimeters (mm), medium length bar having a length B of about 39 mm, and long bar having a length C of about 61 mm. Spacing D depicts the repetition length of one cycle of the second row of linear arrangement of medium length bars and plurality of short bars, which is about 85 mm. Spacing E between the protrusions measured along the longitudinal axis Y of the bars is about 2 mm typically. Spacing F depicts the width of a protrusion including the distance between the protrusions measured along axis X, which is about 12 mm, which represents a spacing between the individual protrusions along axis X of about 2 mm. Spacing G depicts the width of a protrusion measured transverse to its longitudinal axis, which is about 10 mm. Other dimensions, arrangements, and spacing of the protrusions can be used to provide the functionality of the present disclosure. For example, variable width and height (and ratios of height to width) to suite the end-use application, type of carpet can be predetermined, e.g., low or high traffic areas, residential or commercial installation sites, sound proofing or insulation, etc.

FIG. 7 depicts a second surface of the cross-linked foamed sheet with second embossed pattern 800. In one aspect, second embossed pattern 800 is different from first embossed pattern 700. Thus, pattern 800 comprises an arrangement of pyramidal structures having a base 804 at the surface of the foamed sheet and an apex 802 projecting from base 804. Other structures can be employed, for example, a 3-D n-gon-like structure having any one of a semi-cylinder or semi-torus, a cone, a cuboid, a prism, a pyramid, and/or a frustum of a pyramid, and any combination of two or more of such three-dimensional polygons. Such pattern 800 can function to hold and/or prevent lateral motion between the underlay and flooring material, for example, by engaging the laminate of a flooring material, e.g., carpet. The height of apex 802 and/or apex spacing 806 can be configured to engage with that of the laminate stitches of a carpet.

Although the present disclosure has been described in conjunction with specific embodiments thereof, it is evident that many alternatives, modifications and variations will be apparent to those skilled in the art. The present disclosure will now be described with reference to the following non-limiting example.

Non-Limiting Specific Example—Preparation and Characterization of Embossed, Chemically Cross-Linked, Foamed Polyolefin Sheet

Continuous cross-linked polyethylene foams were prepared in accordance with the method illustrated in FIG. 2A, from raw materials comprising: LD 322, Low Density Polyethylene resin obtained from Carmel Olefins, Haifa Bay, Israel; 1 PHR of Perkadox BC-FF obtained from AKZO NOBEL; 20 PHR of UNIFOAM AZ VI-50 Azodicarbonamide obtained from HEBRON-OTZUKA Chemicals; andl % Brown Masterbatch obtained from Tosaf Compounds.

In another embodiment, 2.5 PHR, 4 PHR, 5 PHR, or 10 PHR of natural cork particles obtained from BeitHasha'am, an agent of Amorim can be added.

The mixture of raw materials was fed into a Banbury mixer heated to a temperature of about 150° C., thereby forming a molten blend of the raw materials. Via a hopper, the melt was fed into an extrusion line as described above and via a coat-hanger die to produce a polymeric sheet. This preliminary sheet was directly transferred via a 3 rolls calendar to form a polymeric sheet of uniform thickness 2 mm.

The continuous sheet was conveyed into a conveyer oven consisting of a first temperature section adapted to radiate heat at a temperature of 150° C. (being the temperature for activating the dicumyl Peroxide followed by a second temperature section adapted to radiate heat at a temperature of 230° C. (being the temperature for activating the azodicarbonamide. As a result of this double stage heating of the sheet, a cross-linked polyethylene foam is obtained. The at least partially cross-linked, foamed sheet was then cooled after exiting the double stage oven to at least partially set the sheet, and then the sheet was heated by infra-red heaters prior to being taken up by embossing rolls, which comprised a pair of pinch rolls having a transferable embossed pattern on one or both rolls to provide one or both of the sheet surfaces with a patterned of raised features on one or both surfaces (e.g., bars with rounded ends on one surface, optionally a plurality of pyramidal shapes on the opposite surface) of predetermined length, height, width, and spatially arrangement suitable for controlling the transport of gas (e.g., air) when compressed by a load during use.

Finally, the sheet of at least partially cross-linked polyethylene embossed foam sheet exiting the conveyer oven was cooled using water chiller chromed rolls and rolled on a winder system.

Tables 1 and 2 presents averaged mechanical parameters of representative 9.6 millimeter and 9.3 millimeter thickness samples, respectively, taken from four continuous cross-linked polyethylene embossed foams produced as described above. Specifically, three to five samples were cut off strips of 1.5.times.1.5 m² which were taken from a 200 m long sheet of the produced foams.

The transverse and longitudinal tensile strengths were measured following ASTM D412 using a Lloyd Instruments LR10K Material Testing Machine; The transverse and longitudinal elongation at break (%) were measured following ASTM D412 using the same machine; Density was measured following ASTM D3575 using CHYO MJ300 Semi-analytical Balance. Compression deflection was measured following ASTM D3575 using the LR10K in compression mode. Tear resistance was measured following ASTM D624, Compression Set following ASTM D3575, and Shore hardness by ASTM D2240.

TABLE 1
Mechanical properties of a 9.6 millimeter,
cross-linked polyethylene foam sample.

| | Testing | Average | |
|---|---|---|---|
| Test Performed | Standards | Result | Units |
| Average Density | ASTM D3575 | 2.39 | lb/ft³ |
| Tensile Strength | ASTM D412 | 65.83 | psi |
| Elongation (% to break) | ASTM D412 | 130.96 | % |
| Tear Resistance | ASTM D624 | 15.60 | psi |
| Compressive Deflection 25% | ASTM D3575 | 4.28 | psi |
| Compressive Deflection 50% | ASTM D3575 | 11.97 | psi |
| Compression Set @ 50% - | ASTM D3575 | 59.75 | % |
| ½ hour recovery | | | |
| Compression Set @ 50% - | ASTM D3575 | 67.50 | % |
| 2 hours recovery | | | |
| Compression Set @ 50% - | ASTM D3575 | 72.80 | % |
| 24 hours recovery | | | |
| Hardness Shore OO | ASTM D2240 | 55.75 | Shore OO |

TABLE 2
Mechanical properties of a 9.3 millimeter,
cross-linked polyethylene foam sample.

| | Testing | Average | |
|---|---|---|---|
| Test Performed | Standards | Result | Units |
| Average Density | ASTM D3575 | 2.53 | lb/ft³ |
| Tensile Strength | ASTM D412 | 79.62 | psi |
| Elongation (% to break) | ASTM D412 | 159.23 | % |
| Tear Resistance | ASTM D624 | 15.70 | psi |
| Compressive Deflection 25% | ASTM D3575 | 4.48 | psi |
| Compressive Deflection 50% | ASTM D3575 | 12.24 | psi |
| Compression Set @ 50% - | ASTM D3575 | 62.65 | % |
| ½ hour recovery | | | |
| Compression Set @ 50% - | ASTM D3575 | 67.75 | % |
| 2 hours recovery | | | |
| Compression Set @ 50% - | ASTM D3575 | 72.45 | % |
| 24 hours recovery | | | |
| Hardness Shore OO | ASTM D2240 | 59.25 | Shore OO |

The transverse tensile elongation and longitudinal tensile elongation refer to the % of elongation until break of the foam when pulled in transverse or longitudinal direction. The transverse tensile and longitudinal strengths (psi) are the maximum measured forces applied at the transverse or longitudinal directions, respectively, that is measured as the material sample breaks. The compression deflection (psi) is the measured force which is deflected by the foam after being compressed by 25% or 50%, respectively, to its ambient thickness

The values presented in Tables 1 and 2 show that embossed polyolefin based foams exhibit physical properties compatible with requirements needed for the various applications suggested herein such as, in underlayment, audio or thermal insulation, backing, mat, etc.

Anti-microbial material can be added to the polymeric material to impart microbial control. Also, various air fresheners and/or fragrances can be incorporated into the sheet such that during use, a fragrance is discharged.

Furthermore, while certain embodiments of the present disclosure have been illustrated with reference to specific combinations of elements, various other combinations may also be provided without departing from the teachings of the present disclosure. Thus, the present disclosure should not be construed as being limited to the particular exemplary embodiments described herein and illustrated in the Figures, but may also encompass combinations of elements of the various illustrated embodiments and aspects thereof.

1. A polymeric sheet comprising: a first surface and a second surface; and a first embossed pattern on at least one of the first surface or the second surface, wherein the embossed pattern is at least two protrusions, the at least two protrusions direct, impede, and/or control gas movement between the at least two protrusions when arranged in contact with a surface and externally compressed.

2. The polymeric sheet of claim 1, wherein the sheet is at least partially cross-linked.

3. The polymeric sheet of claim 1, wherein the sheet comprises a thermoplastic, a curable elastomer, or thermoplastic elastomer.

4. The polymeric sheet of claim 1, wherein the sheet comprises a closed-cell foam.

5. The polymeric sheet of claim 1, wherein the at least two protrusions comprise at one of:
(a) an average height of about 1 millimeter to about 4 millimeter;
(b) an average spacing there between of between 0 and about 50 millimeters; or
(c) a height to width ratio (aspect ratio) of about 0.05 to about 0.4.

6. The polymeric sheet of claim 5, wherein the at least two protrusions comprise at least one of (a) or (b) in combination with (c).

7. The polymeric sheet of claim 5, wherein the sheet comprises a second embossed pattern on the second surface different from the first embossed pattern.

8. The polymeric sheet of claim 7, wherein the second embossed pattern is a plurality of pyramidal structures configured for contacting a flooring material.

9. The polymeric sheet of claim 1, further comprising one or more laminated layers selected from a thermoplastic film, a thermoplastic elastomer film, water vapor barrier film, adhesive layer such as a pressure sensitive or peel-and-stick adhesive, a cork-filled polymer sheet, a soft or hard flooring material, and an open cell foamed sheet.

10. A process for producing a continuous embossed polymeric sheet, the process comprising the steps of:
i) continuously feeding into a mixing arrangement set at a temperature of between 60° C. and 200° C. a blend of at least one polymer resin, optionally a blowing agent, and optionally a cross-linking agent to form therein a homogenous melt;
ii) transferring said melt into an extrusion line constructed to form a continuous sheet of said melt;
iii) optionally, conveying the continuous sheet into a heating module for heating said continuous sheet to a first temperature to obtain a polymeric sheet at least partially chemically cross-linked, said first temperature being lower than that required for activating said optional blowing agent;
iv) optionally, heating the cross-linked polymeric sheet to a second temperature allowing activation of said blowing agent, to obtain a continuous, at least partially cross-linked foamed polymeric sheet; and
v) embossing on at least one surface of said heated polymeric sheet an arrangement of at least two protrusions.

11. The process of claim 10, wherein the sheet is at least partially chemically cross-linked as defined in step (iii), or physically at least partially cross-linked, or at least partially cross-linked after step (v).

12. (canceled)

13. The process of claim 10, wherein the polymeric sheet is physically foamed after step (v).

14. The process of claim 10, wherein step (v) is performed between step (ii) and step (iii).

15. The process of claim 10, wherein step (v) provides at least two protrusions comprising at least one of:
(a) an average height of about 1 millimeter to about 4 millimeter;
(b) an average spacing there between of between 0 and about 50 millimeters; or
(c) a height to width ratio (aspect ratio) of about 0.05 to about 0.4.

16. The process of claim 10, wherein the at least two protrusions comprise at least one of (a) or (b) in combination with (c).

17. The process of claim 10, further comprising cooling and then heating polymeric sheet from step (iv) prior to performing step (v).

18. The process of claim 10, wherein step (v) further provides embossing on a second surface of the polymeric sheet different from that of a first surface of the polymeric sheet wherein the second surface a plurality of pyramidal structures configured for contacting a flooring material.

19. (canceled)

20. The process of claim 14, further comprising step (vi) laminating one or more layers selected from a thermoplastic film, a thermoplastic elastomer film, water vapor barrier film, adhesive layer such as a pressure sensitive or peel-and-stick adhesive, a cork-filled polymer sheet, a soft or hard flooring material, and an open cell foamed sheet.

21. A method of controlling gas flow between a surface and a polymeric sheet, the method comprising:
providing a polymeric sheet comprising a first surface configured for contacting the surface; and an opposing second surface; wherein the first surface comprises a first embossed pattern of at least two protrusions configured to direct, impede, and/or control gas movement between the surface and the polymeric sheet.

22. The method of claim 21, wherein the second surface comprises a second embossed pattern.

23. The method of claim 21, wherein the sheet is at least partially cross-linked or wherein the sheet comprises closed-cell foam.

24. (canceled)

25. (canceled)

26. The method of claim 21, wherein step (v) provides at least two protrusions comprising at least one of:
(a) an average height of about 1 millimeter to about 4 millimeter;
(b) an average spacing there between of between 0 and about 50 millimeters; or
(c) a height to width ratio (aspect ratio) of about 0.05 to about 0.4.

27. The method of claim 26, wherein the at least two protrusions comprise at least one of (a) or (b) in combination with (c).

28-40. (canceled)
